(19) United States
(12) Patent Application Publication
(10) Pub. No.: US 2018/0032393 A1
(43) Pub. Date: Feb. 1, 2018

(54) SELF-HEALING SERVER USING ANALYTICS OF LOG DATA

(71) Applicant: International Business Machines Corporation, Armonk, NY (US)

(72) Inventors: Kavita Chavda, Alpharetta, GA (US); Manoj Palaniswamy Vasanthakumari, Bangalore (IN)

(21) Appl. No.: 15/224,708

(22) Filed: Aug. 1, 2016

(51) Int. Cl. G06F 11/07

(52) U.S. Cl. CPC G06F 11/0793; G06F 11/079; G06F 11/0709

(57) ABSTRACT

A system, method and program product for providing self-healing for a server. A system is provided having: a server operating system (OS) and at least one application adapted to run on the server system; a system for collecting log information from the server OS and the at least one application and for forwarding the log information to a local indexing engine to generate indexed log information; a set of micro analytics engines, each adapted to analyze indexed log information associated with a respective one of the server OS and at least one application, and to generate detected anomaly conditions; and a corrective action system that inputs a detected anomaly condition against a set of micro automation codes to implement a corrective action.

### TECHNICAL FIELD

The subject matter of this invention relates to self-healing servers, and more particularly to a system and method of implementing self-healing servers based on analytics of machine generated data such as log, metric, and event information.

### BACKGROUND

In a large scale information technology (IT) environment, there may be dozens or even hundreds of servers that need to be managed to ensure they are available to meet the needs of customers relying on them. Server administration is complex task, which may involve alert conditions being sent to an operations team and/or tickets being sent to administrators, e.g., based on monitoring probes. Often, problems are fixed based on the knowledge of the administrator or with scripts that lack any real intelligence. This process is highly reactive in nature, which makes problem identification and resolution extremely time consuming and expensive.

The use of analytics to help identify issues and fix problems is one potential approach to reduce the burden of server administration. In the traditional approach, servers generate data files that are archived to an external database or streamed to an external index server using an external gateway, which indexes the data files. Once indexed, an external analytics server is run against the data files to generate a set of analytics insights. An external automation system can then be used to automate actions when trigger conditions are met. Unfortunately, this approach comes with significant costs and limitations, as various external systems are required to provide the analytics.

### SUMMARY

Aspects of the disclosure provide self-healing servers in which no additional external servers or systems are required. Instead, logs from applications and the server are indexed and analyzed locally within the server itself. Micro automation codes run within the server implement corrective actions internally when trigger conditions are met.

A first aspect provides a server system, comprising: a server operating system (OS) and at least one application adapted to run on the server system; a system for collecting log information from the server OS and the at least one application and for forwarding the log information to a local indexing engine to generate indexed log information; a set of micro analytics engines, each adapted to analyze indexed log information for a respective one of the server OS and at least one application, and to generate detected anomaly conditions; and a corrective action system that evaluates a detected anomaly condition against a set of micro automation codes to implement a corrective action.

A second aspect provides a computer program product stored on a computer readable storage medium, which when executed by a server system, provides self-healing, the program product comprising: program code for collecting log information from a server operating system (OS) and at least one application, and for forwarding the log information to a local indexing engine to generate indexed log information; program code for instantiating a set of micro analytics engines, each adapted to analyze indexed log information for a respective one of the server OS and at least one application, and to generate detected anomaly conditions; and program code that evaluates a detected anomaly condition against a set of micro automation codes to implement a corrective action.

A third aspect provides a computerized method that provides self-healing for a server system, comprising: providing a server operating system (OS) and at least one application adapted to run on the server system; collecting log information from the server OS and the at least one application; forwarding the log information to a local indexing engine to generate indexed log information; utilizing a set of micro analytics engines to analyze indexed log information associated with the server OS and at least one application, and to generate detected anomaly conditions; and evaluating a detected anomaly condition against a set of micro automation codes to implement a corrective action.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a self-healing server system according to embodiments.

FIG. 2 shows a flow diagram of self-healing process according to embodiments.

FIG. 3 shows a server system according to embodiments.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

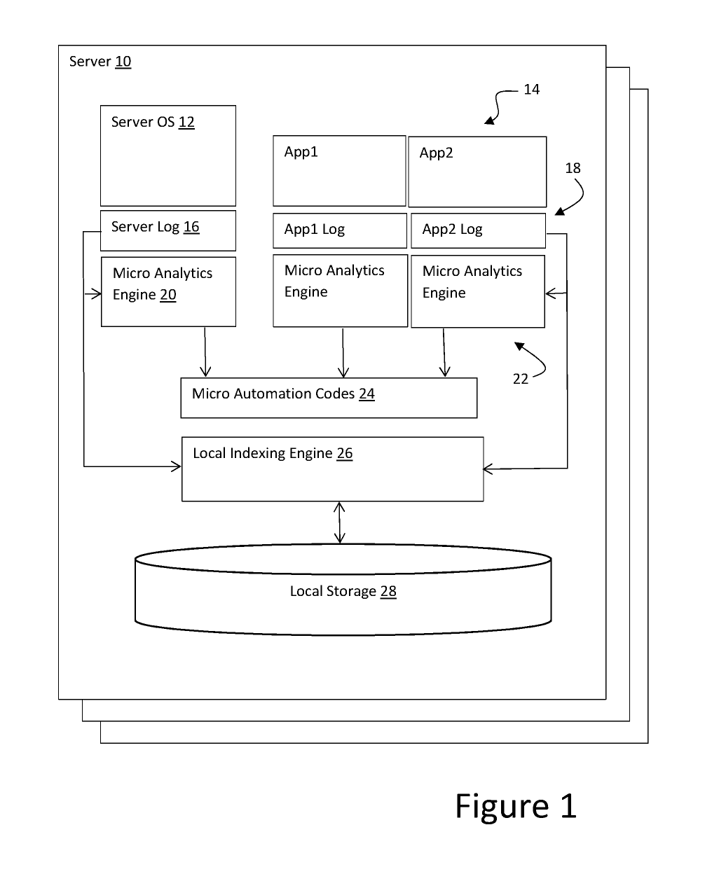

Referring now to the drawings, FIG. 1 depicts a functional diagram of a server system 10, which may be one of a set of servers, each having an integrated self-healing system. In this illustrative embodiment, server system 10 includes a server operating system (OS) 12 and one or more applications 14 (App1, App2) implemented to perform relevant server functions (e.g., mail serving, file serving, application serving, web serving, etc.). A local indexing engine 26 is utilized to collect and index a server log 16 and application logs 18 from each of the server OS 12 and applications 14, respectively. The resulting indexed information is then stored in a local storage 28. It is noted that both the local indexing engine 26 and local storage 28 are components typically implemented in most servers, so these existing components can be readily leveraged.

The server log 16 and application logs 18 generally comprise event information relevant to the execution of the relevant OS or application. The logs 16, 18 may comprise both structured and unstructured information, and may be generated in a predefined logging standard, such as syslog, or be generated in an ad hoc manner. Regardless, for the purposes of this disclosure, the phrase “log information” refers to any machine generated data (e.g., logs, events, metrics, etc.). The local indexing engine 26 allows the log information to be efficiently stored and retrieved.

Each of the server OS 12 and applications 14 are associated with a customized micro analytics engine 20, 22 that analyzes the indexed log information of the associated server OS/applications e.g., in real time not using an external process. Accordingly, as log information is indexed and stored, it can be analyzed by a respective micro analytics engine 20, 22 immediately thereafter or in parallel. The micro analytics engines 20, 22 may be embedded and run within the server OS 12 and applications 14, or be implemented and run separately. Each micro analytics engine 20, 22 includes one or more algorithms that for example provide: pattern detection, predictive modeling, searching, cognitive learning, etc., of the indexed log information. Illustrative algorithms may include linear models, decision trees/random forests, text analytics, Granger causality, etc. Algorithms may be modular in nature such that they can be interchangeably applied depending on the type of analytics being used.

For example, in a simple case, micro analytics engines 20, 22 may look for basic anomaly conditions, such as threshold values being exceeded, exceptions thrown, restarts, download failures, etc. In more advanced cases, the engines 20, 22 may look for information indicative of performance degradation, e.g., decreasing CPU performance over time, slowing data transfer speeds, etc. In further embodiments, engines 20, 22 may use cognitive analysis of structured and unstructured information to look for patterns such as decreased performance or failures under particular conditions and apply predictive modeling to identify more complex problems.

Each micro analytics engine 20, 22 may be customized for the particular application or OS. For example, a micro analytic engine 22 for a gaming application may be configured to look for problems common to gaming, such as slow graphics, buggy code, etc. Conversely, a micro analytic engine 22 for a mail server may look for problems common to mail services, such as undelivered mail, a denial of services attack using spam, etc.

Different anomaly conditions may be identified with different codes. For example, a coding system may be used to identify the relevant OS/application and an identified anomaly. Thus, for instance, “App1:0001” may be used as a code to indicate that App1 has frozen; “App2:0010” may indicate a memory fault occurred in App2; “OS:0011” may indicate a slow data transfer rate between the server 10 and a set of clients; “OS:0100” may indicate a memory full condition, etc. Obviously, any format or number of codes may be utilized.

Regardless, once an anomaly condition that needs corrective action (i.e., healing) is identified by a micro analytics engine 20, 22, the anomaly condition is evaluated against a set of micro automation codes 24 to trigger a self-healing operation within the server system 10. The micro automation codes 24 may be implemented as a set of scripts that can be written based on the operating system (OS) of the server system 10 and applications 14 running on the server system 10. The micro automation codes 24 may be embedded into the server system 10 as a component, process or executable. Each script performs some corrective action (i.e., self-healing operation) based on an inputted anomaly condition. For example, the above App1:0001 code may trigger the restarting of a service found to be stopped, AP2:0010 may trigger dynamically increasing disk space, OS:0011 may trigger reprioritizing data transfers, OS:0100 may trigger off-loading services to back-up devices, etc. Micro automation codes 24 may be triggered immediately when an anomaly condition is received, or periodically, e.g., based on a seasonality report. Once a micro automation code executes successfully, the anomaly condition may be closed, thus providing continuous self-healing of the server system 10.

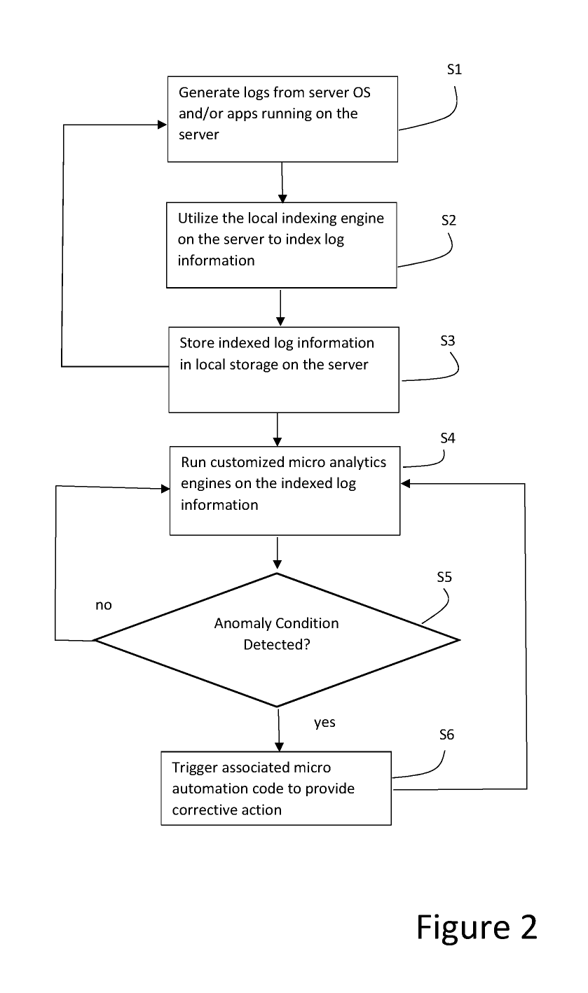

FIG. 2 depicts a flow diagram of an illustrative self-healing server process. At S1, logs 16, 18 are generated from the server OS 12 and/or from applications 14 running on the server system 10. At S2, a local indexing engine 26 on the server system 10 is utilized to index the log information and at S3 the indexed log information is stored in local storage 28 on the server system 10. The process of generating and indexing log information (S1-S3) is generally a continuously looping process. Concurrently, a customized micro analytics engine 20, 22 for each of the server OS 12 and/or applications 14 is run against the associated log information at S4, either in a continuous or periodic fashion. At S5 a determination is made whether an anomaly condition is detected by any of the micro analytics engines 20, 22. If no, the process loops and continues at S4. If yes, an associated micro automation code is triggered to provide a corrective action at S6. Once complete, the anomaly condition is met and the process loops back to S4.

Accordingly, unlike other solutions, the present approach does not require an external analytics system to identify and address problems. Instead, anomaly conditions can be addressed on the fly within the server system 10 itself. Further, no additional storage systems are required, as local storage 28 can be utilized to store indexed log information. Furthermore, each micro analytics engine 20, 22 can be implemented locally on the server 10 for a particular application 14 or server OS 12.

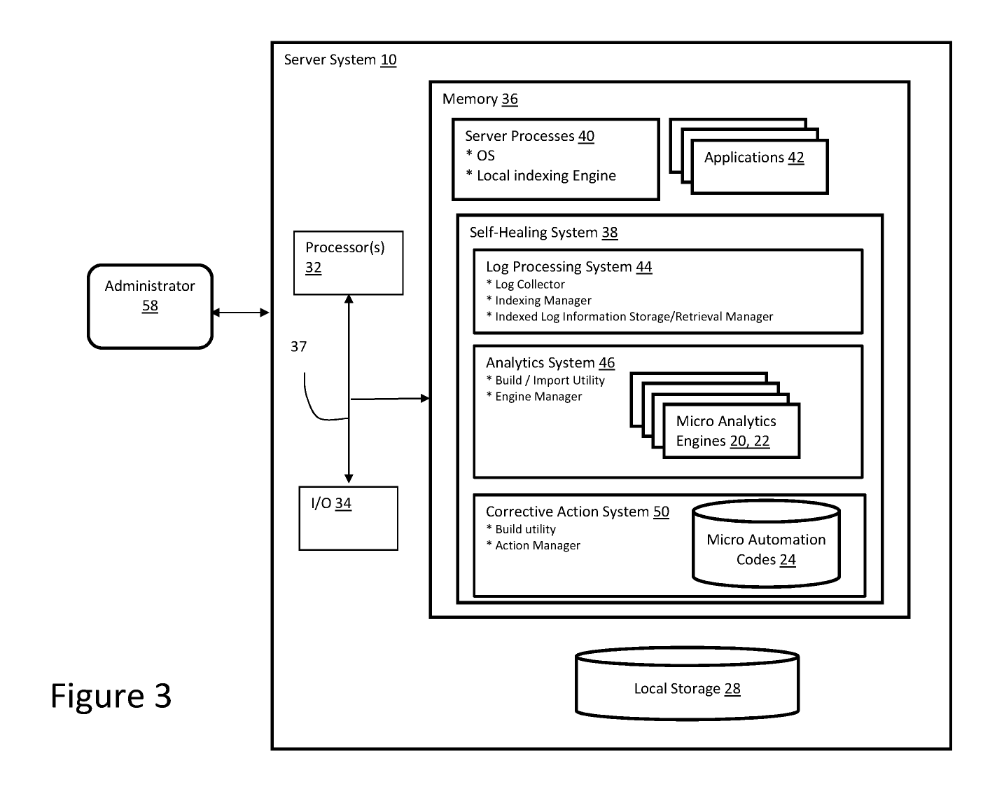

FIG. 3 depicts an illustrative embodiment of a computer implemented version of server system 10 that includes a self-healing system 38 that automatically generates corrective actions within or for the server system 10 in response to detected anomaly conditions. Server system 10 includes various functional elements which may be stored in memory 36 as program products (i.e., software) for execution by one or more processors 32. Among the functional elements are server processes 40, such on operating system and a local indexing engine, as well as one or more applications 42. Also included in server system 10 is local storage 28, which may include a storage area network, flash memory, etc.

Self-healing system 38 is adapted to operate within server system 30 along with server processes 40 and applications 42 either in a stand-alone or integrated manner. Self-healing system 38 includes a log processing system 44 for collecting log information from any server processes 40 and applications 42, forwarding log information to the local indexing engine, and managing the storage and retrieval of indexed log information in local storage 28.

Also included in self-healing system 38 is an analytics system 46 that may include a build/import utility for allowing an administrator 58 to import, build, modify, etc., micro analytics engines 20, 22 for each of the server processes 40 and applications 42. Micro analytics engines 20, 22 may be implemented as stand-alone programs, libraries, objects, etc., or be directly integrated into respective server processes 40 and/or applications 42. Once instantiated, an engine manager may be utilized to manage, schedule, and oversee the execution of the micro analytics engines 20, 22. Regardless, each micro analytics engines 20, 22 analyzes indexed log information of associated server processes 40 and applications 42. When an anomaly is detected, the engine manager passes the anomaly condition to the corrective action system 50.

Corrective action system 50 inputs and evaluates the detected anomaly condition against a set of micro automation codes 24, and triggers a corrective action. A build utility may be provided to allow an administrator 58 or the like to create, import and edit micro automation codes 24, which may be implemented as scripts. An action manager may be implemented to track and oversee any corrective actions that may take place, i.e., ensuring the corrective action is completed with errors, closing out corrective actions that are complete, etc.

It is understood that self-healing system 38 may be implemented as a computer program product stored on a computer readable storage medium. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Python, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Server system 30 may comprise any type of computing device and for example includes at least one processor 32, memory 36, an input/output (I/O) 34 (e.g., one or more I/O interfaces and/or devices), and a communications pathway 37. In general, processor(s) 32 execute program code which is at least partially fixed in memory 36. While executing program code, processor(s) 32 can process data, which can result in reading and/or writing transformed data from/to memory and/or I/O 34 for further processing. The pathway 37 provides a communications link between each of the components in server system 30. I/O 34 can comprise one or more human I/O devices, which enable a user to interact with server system 30. Server system 30 may also be implemented in a distributed manner such that different components reside in different physical locations.

Furthermore, it is understood that the self-healing system 38 or relevant components thereof (such as an API component, agents, etc.) may also be automatically or semi-automatically deployed into a computer system by sending the components to a central server or a group of central servers. The components are then downloaded into a target computer that will execute the components. The components are then either detached to a directory or loaded into a directory that executes a program that detaches the components into a directory. Another alternative is to send the components directly to a directory on a client computer hard drive. When there are proxy servers, the process will select the proxy server code, determine on which computers to place the proxy servers' code, transmit the proxy server code, then install the proxy server code on the proxy computer. The components will be transmitted to the proxy server and then it will be stored on the proxy server.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A server system, comprising:
a server operating system (OS) and at least one application adapted to run on the server system;
a system for collecting log information from the server OS and the at least one application and for forwarding the log information to a local indexing engine to generate indexed log information;
a set of micro analytics engines, each adapted to analyze indexed log information for a respective one of the server OS and at least one application, and to generate detected anomaly conditions; and
a corrective action system that evaluates a detected anomaly condition against a set of micro automation codes to implement a corrective action.

2. The server system of claim 1, wherein the indexed log information is stored in a local storage system on the server.

3. The server system of claim 1, wherein the log information includes structured and unstructured data.

4. The server system of claim 1, wherein the set of micro analytics engines each include at least one algorithm for providing: pattern detection, predictive modeling, searching, cognitive learning, text analytics, and threshold detection.

5. The server system of claim 1, wherein the micro automation codes are implemented as a set of scripts.

6. The server system of claim 1, wherein the corrective actions include an action selected from a group consisting of: restarting of a service found to be stopped, dynamically increasing disk space, reprioritizing data transfers, and off-loading services to a back-up device.

7. The server system of claim 1, wherein the collecting of log information and analyzing of indexed log information occur in continuous parallel processes.

8. A computer program product stored on a computer readable storage medium, which when executed by a server system, provides self-healing, the program product comprising:
program code for collecting log information from a server operating system (OS) and at least one application and for forwarding the log information to a local indexing engine to generate indexed log information;
program code for instantiating a set of micro analytics engines, each adapted to analyze indexed log information for an associated one of the server OS and at least one application, and to generate detected anomaly conditions; and
program code that evaluates a detected anomaly condition against a set of micro automation codes to implement a corrective action.

9. The computer program product of claim 8, wherein the indexed log information is stored in a local storage system on the server.

10. The computer program product of claim 8, wherein the log information includes structured and unstructured data.

11. The computer program product of claim 8, wherein the set of micro analytics engines each include at least one algorithm for providing: pattern detection, predictive modeling, searching, cognitive learning, text analytics, and threshold detection.

12. The computer program product of claim 8, wherein the micro automation codes are implemented as a set of scripts.

13. The computer program product of claim 8, wherein the corrective actions include an action selected from a group consisting of: restarting of a service found to be stopped, dynamically increasing disk space, reprioritizing data transfers, and off-loading services to a back-up device.

14. The computer program product of claim 8, wherein the collecting of log information and analyzing of indexed log information occur in continuous parallel processes.

15. A computerized method that provides self-healing for a server system, comprising:
providing a server operating system (OS) and at least one application adapted to run on the server system;
collecting log information from the server OS and the at least one application;
forwarding the log information to a local indexing engine to generate indexed log information;
utilizing a set of micro analytics engines to analyze indexed log information for the server OS and at least one application, and to generate detected anomaly conditions; and
evaluating a detected anomaly condition against a set of micro automation codes to implement a corrective action.

16. The computerized method of claim 15, wherein the indexed log information is stored in a local storage system on the server.

17. The computerized method of claim 15, wherein the log information includes structured and unstructured data.

18. The computerized method of claim 15, wherein the set of micro analytics engines each include at least one algorithm for providing: pattern detection, predictive modeling, searching, cognitive learning, text analytics, and threshold detection.

19. The computerized method of claim 15, wherein the micro automation codes are implemented as a set of scripts.

20. The computerized method of claim 15, wherein the collecting of log information and analyzing of indexed log information occur in continuous parallel processes.
